(19) United States
(12) Patent Application Publication
(10) Pub. No.: US 2026/0295480 A1
(43) Pub. Date: Oct. 1, 2026

(54) DEVICE AND METHOD FOR AUTOMATICALLY RECOVERING LOGGING DATA STORAGE

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD., Beijing (CN)

(72) Inventors: Sanguo LI, Beijing (CN); Jinhai ZHAO, Beijing (CN); Jibo LI, Beijing (CN); Yanbo ZONG, Beijing (CN); Zuyang ZHU, Beijing (CN)

(21) Appl. No.: 19/142,873

(22) PCT Filed: Jan. 3, 2024
(86) PCT No.: PCT/CN2024/070246

§ 371 Date: Jun. 24, 2025

(30) Foreign Application Priority Data
Jan. 3, 2023 (CN) 202310001490.6

(51) Int. Cl. B01D 33/80; B01D 33/01; B01D 33/46; B01D 33/48; E21B 21/06; E21B 49/00; G06T 7/00; G06T 7/50; G06V 10/141; G06V 20/50; H04N 23/56; H04N 23/60; H04N 23/74

(52) U.S. Cl. CPC B01D 33/804; B01D 33/01; B01D 33/463; B01D 33/48; E21B 21/065; E21B 49/00; G06T 7/0002; G06T 7/50; G06V 10/141; G06V 20/50; H04N 23/56; H04N 23/64; H04N 23/74; G06T 2207/10064

(57) ABSTRACT

An automatic recovery device can recover, from a shale shaker, a logging data storage released into a wellbore. The automatic recovery device has an image acquisition module disposed at a shale shaker and configured to acquire images of a screen surface of the shale shaker; a trapping module disposed at an outlet of the shale shaker and configured to trap an identified logging data storage; a controller coupled to the image acquisition module and the trapping module. The controller is configured to: activate the image acquisition module to start acquiring images of the screen surface of the shale shaker; receive the images from the image acquisition module; identify whether a logging data storage is present in the images; and activate the trapping module to trap the identified logging data storage from the shale shaker in response to the presence of a logging data storage in the images.

### TECHNICAL FIELD

The present invention relates to the technical field of measurement while drilling (MWD) and logging while drilling (LWD), and particularly to a device and method for automatically recovering a logging data storage, which performs continuous monitoring, identification, and recovery of a releasable micro-storage for data transmission while drilling and a micro-tracer which is released in a wellbore and carried to the ground of the earth (i.e. surface of the earth) by drilling fluid.

### BACKGROUND

Logging while drilling (LWD) generally refers to measuring physical parameters of formation rock during drilling and transmitting the measurement results to the ground of the earth for processing through a data transmission system. With the improvement of measurement accuracy, LWD tools generate large amounts of data during operations. The current downhole-to-ground data transmission rate is not enough to transmit those data losslessly to the ground, resulting in the inability to fully utilize the real-time guidance role of these LWD tools. To solve this problem, a downhole data transmission technology which uses releasable data storages has been developed. The LWD tool is installed in a releasable drill collar. During logging, LWD measurement data are first transferred to a logging data storage, which is then released into the drilling annulus at an appropriate time and carried by drilling fluid to a shale shaker on the ground for recovery, data reading, and application.

The key to this technology is the ability to identify and recover the logging data storages at the shale shaker. However, in practical applications, due to the large amount of mud, cuttings, and other debris at the shale shaker, manual identification of a small number of Logging data storages is prone to missing targets.

Existing technologies have studied methods for identifying and recovering logging data storages. For example, Patent ZL201610880811.4 provides a recovery method that uses a built-in wireless receiving device in the recovery device to identify logging data storages through the connection between a signal transmitting device of the logging data storage and the built-in wireless receiving device of the recovery device, enabling recovery of logging data storages with built-in wireless data communication functions. The paper “A Distributed Microchip System for Subsurface Measurement” describes a device that uses a strong magnetic tool and a filter screen for recovery, which acts on the magnetism caused by the current in the logging data storage. However, due to the weak magnetism and the vibration of the shale shaker, the recovery effect is poor.

With the development of technology, emerging logging data storages only contain circuit boards without batteries and antennas, unable to send wireless signals or generate magnetism. Therefore, the above traditional recovery methods cannot recover such logging data storages. There is an urgent need for a releasable logging data storage recovery solution to achieve efficient and accurate automated recovery operations.

Information disclosed in the background art of this invention is only intended to deepen the understanding of the general background of the invention and should not be construed as an admission or any form of suggestion that this information constitutes prior art known to those skilled in the art.

### SUMMARY

To solve the above problems, the present disclosure provides a device and method for automatically recovering a logging data storage, which monitors, identifies, and traps the released logging data storage carried by drilling fluid to the shale shaker, thereby completing recovery, achieving automated recovery of the logging data storage, reducing labor consumption, improving recovery ratio, reducing power consumption, and increasing throughput.

First Aspect of the present disclosure provides an automatic recovery device for recovering a logging data storage released into a wellbore comprising:
an image acquisition module disposed at a shale shaker and configured to acquire images of a screen surface of the shale shaker;
a trapping module disposed at an outlet of the shale shaker and configured to trap an identified logging data storage;
a controller coupled to the image acquisition module and the trapping module, and configured to:
activate the image acquisition module to start acquiring images of the screen surface of the shale shaker in response to receiving a release signal indicating that the logging data storage has been released into the wellbore;
receive the images from the image acquisition module;
identify whether a logging data storage is present in the images; and
activate the trapping module to trap the identified logging data storage from the shale shaker in response to the presence of a logging data storage in the images.

According to the automatic recovery device of the first aspect, the controller is further configured to: identify whether the logging data storage is present in the image by recognizing a shape of particulate matter on the shale shaker shown in the image.

According to the automatic recovery device of the first aspect, activating the image acquisition module in response to receiving the release signal comprises:
determining a depth signal of the released position of the logging data storage, a diameter of the wellbore, and a flow rate of drilling fluid returning up to the ground;
calculating an approximate time for the logging data storage to reach the shale shaker based on the depth signal, the diameter of the wellbore, and the flow rate; and
activating the image acquisition module to start acquiring images of the screen surface of the shale shaker based on the approximate time.

According to the automatic recovery device of the first aspect, it further comprises a spray module configured to flush the trapping module in response to a control command to prevent or eliminate blockage.

According to the automatic recovery device of the first aspect, the controller is further configured to:
determine that a blockage has occurred at the trapping module based on sensed data from a sensor; and
activate the spray module to flush the trapping module in response to the blockage.

According to the automatic recovery device of the first aspect, the image acquisition module includes a fluorescent excitation device configured to emit fluorescent excitation light to the shale shaker in response to a controller command, wherein the fluorescent excitation light is configured to excite an encapsulation material of the logging data storage to generate fluorescence.

According to the automatic recovery device of the first aspect, the controller is further configured to: identify whether the logging data storage is present in the image by recognizing the shape and/or fluorescence of particulate matter on the shale shaker shown in the image.

According to the automatic recovery device of the first aspect, the image acquisition module further includes a photosensor and a natural light fill light, the photosensor configured to monitor light intensity at the shale shaker and control the natural light fill light to automatically fill light in response to the light intensity meeting a predefined fill light conditions.

According to the automatic recovery device of the first aspect, the trapping module is disposed at the outlet of the shale shaker and includes a guide plate and a trapping baffle, and a spacing between the guide plate and the trapping baffle is set according to structural dimensions of the logging data storage to intercept the logging data storage.

According to the automatic recovery device of the first aspect, the controller is further configured to issue a reminder signal in response to the presence of a logging data storage in the image.

Second aspect of the present disclosure provides a method for recovering a logging data storage released into a wellbore comprising:
receiving a release signal indicating that the logging data storage has been released into the wellbore;
activating an image acquisition module to start acquiring images of a screen surface of a shale shaker in response to receiving the release signal;
receiving the images from the image acquisition module;
identifying whether the logging data storage is present in the images; and
activating a trapping module to trap the identified logging data storage from the shale shaker in response to the presence of the logging data storage in the images.

According to the method of the second aspect, it further comprises: identifying whether the logging data storage is present in the image by recognizing a shape of particulate matter on the shale shaker shown in the image.

According to the method of the second aspect, activating the image acquisition module in response to receiving the release signal comprises:
determining a depth signal of the released position of the logging data storage, a diameter of the wellbore, and a flow rate of drilling fluid returning up to the ground;
calculating an approximate time for the logging data storage to reach the shale shaker based on the depth signal, the diameter of the wellbore, and the flow rate; and
activating the image acquisition module to start acquiring images of the screen surface of the shale shaker based on the approximate time.

According to the method of the second aspect, it further comprises:
determining that a blockage has occurred at the trapping module based on sensed data from a sensor; and
activating a spray module to flush the trapping module in response to the blockage to eliminate the blockage.

According to the method of the second aspect, it further comprises:
activating a fluorescent excitation device to emit fluorescent excitation light to the shale shaker, wherein the fluorescent excitation light can excite the encapsulation material of the logging data storage to generate fluorescence.

According to the method of the second aspect, it further comprises: identifying whether the logging data storage is present in the image by recognizing the shape and/or fluorescence of particulate matter on the shale shaker shown in the image.

According to the method of the second aspect, the trapping module is disposed at an outlet of the shale shaker and comprises a guide plate and a trapping baffle, the method further comprising: setting a spacing between the guide plate and the trapping baffle according to structural dimensions of the logging data storage to intercept the logging data storage.

According to the method of the second aspect, it further comprises issuing a reminder signal in response to the presence of a logging data storage in the image.

Third aspect of the present disclosure provides a controller comprising:
a processor; and
a non-transitory machine-readable storage medium storing computer program instructions that, when executed by the processor, cause the processor to implement the method according to the second aspect.

Fourth aspect of the present disclosure provides a non-transitory machine-readable storage medium storing computer program instructions that, when executed by a processor, cause a processor to implement the method according to the second aspect.

Fifth aspect of the present disclosure is a program product having computer program instructions that, when executed by a processor, cause the processor to implement the method according to the second aspect.

Other features and advantages of the present invention will be set forth in the following description. Part of them will become apparent from the description, or may be learned through the practice of the present invention. The objectives and other advantages of the present invention may be realized and obtained through the structures particularly pointed out in the description, claims, and drawings.

### BRIEF DESCRIPTION OF THE DRAWINGS

The drawings illustrate various examples of aspects of the present disclosure, which are used together with the description to explain the principles of the present disclosure. Those skilled in the art will understand that the specific embodiments shown in the drawings are exemplary only and are not intended to limit the scope of the present disclosure. It should be recognized that one element in some examples may also be designed as multiple elements, or multiple elements may be designed as one element. In some examples, an element shown as an internal component of another element may also be implemented as an external component of the other element, and vice versa. In the drawings:

FIG. 1 shows an overall schematic diagram of a recovery system 10 for a logging data storage according to an embodiment of the present disclosure;

FIG. 2 shows a structural schematic diagram of an automatic recovery device 200 for recovering a logging data storage according to an embodiment of the present disclosure;

FIGS. 3a and 3b show the extraction of the shape of particulate matter in an image by a controller;

FIG. 4 shows a structural schematic diagram of an image acquisition module according to an embodiment of the present disclosure;

FIG. 5 shows a structural schematic diagram of a trapping module according to an embodiment of the present disclosure;

FIG. 6 shows a flowchart of a method for recovering a logging data storage according to an embodiment of the present disclosure; and

FIG. 7 shows a structural diagram of a controller.

### DETAILED DESCRIPTION

The embodiments of the present disclosure will be described in detail below with reference to the drawings, so that those skilled in the art can fully understand how the present embodiments uses technical means to solve technical problems and achieve technical effects, and can implement the present embodiments accordingly based on the described implementation process. It should be noted that, as long as there is no conflict, the various embodiments of the present disclosure and the various features in the embodiments may be combined with each other, and the formed technical solutions fall within the protection scope of the present disclosure.

Although the flowcharts describe operations as sequential processes, many of the operations may be implemented in parallel, concurrently, or simultaneously. The order of operations may be rearranged. The process may be terminated when its operations are completed, but may also include additional steps not shown in the drawings. The process may correspond to a method, function, procedure, subroutine, subprogram, etc.

A computer device or controller includes user equipment and network device. User equipment or clients include, but are not limited to, computers, smartphones, PDAs, etc.; network device includes, but is not limited to, a single network server, a server group composed of multiple network servers, or a cloud composed of a large number of computers or network servers based on cloud computing. A computer device may implement the present embodiments alone or may access a network and implement the present embodiments through interactive operations with other computer devices in the network. Networks in which computer devices are located include, but are not limited to, the Internet, wide area networks, metropolitan area networks, local area networks, VPN networks, etc.

Here, terms such as “first” and “second” may be used to describe various units, but these units should not be limited by these terms. These terms are only used to distinguish one unit from another. The term “and/or” used here includes any and all combinations of one or more of the associated listed items. When a unit is referred to as being “connected” or “coupled” to another unit, it may be directly connected or coupled to the other unit, or an intermediate unit may be present.

The terms used herein are only for describing specific embodiments and are not intended to limit the exemplary embodiments. It should be understood that the terms “comprise” and/or “include” used herein specify the presence of stated features, integers, steps, operations, units, and/or components, but do not exclude the presence or addition of one or more other features, integers, steps, operations, units, components, and/or combinations thereof.

Further, those skilled in the art should understand that the logging data storage is not limited to a storage storing LWD measurement data, but also includes tracers storing MWD (Measurement While Drilling) data and other storages storing data and performing data transmission by being released into a wellbore. MWD generally refers to the measurement of drilling engineering parameters such as well deviation, azimuth, and tool face. Sometimes, MWD generally refers to all downhole measurements during drilling. The tracer generally integrates sensors and a storage into a small-size detector, which is dropped into the wellbore to circulate with drilling fluid to measure wellbore temperature and pressure, and is finally carried by drilling fluid to a shale shaker at ground of the earth (or surface of the earth) for recovery and data reading. In the present disclosure, for simplicity, the description is given by taking LWD measurement as an example, but those skilled in the art can understand that the present disclosure is not limited thereto.

Next, the structural components, connection modes, and functional principles of the embodiments of the present invention will be described in detail based on the drawings. Although the logical order of operations is shown in describing the operational principles of the system structure, in some cases, the operations shown or described may be performed in an order different from that here.

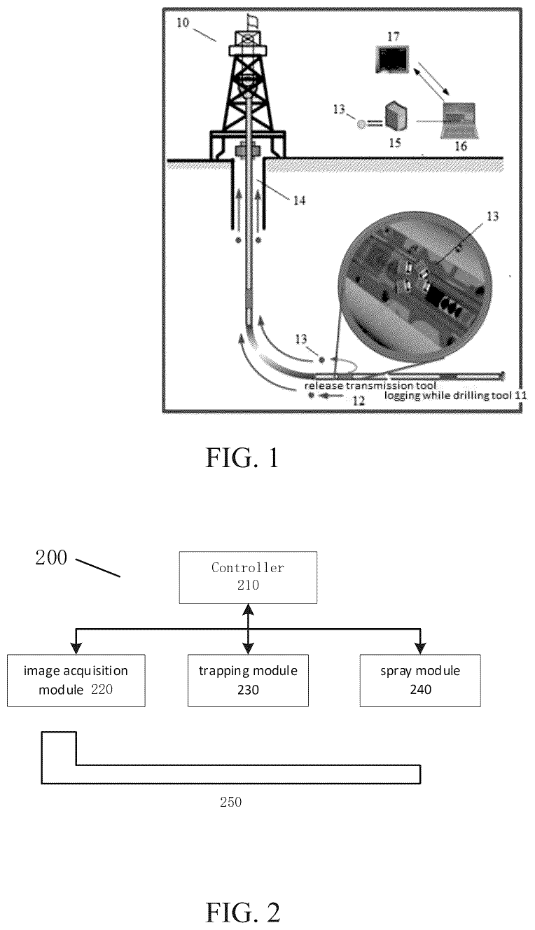

FIG. 1 shows an overall schematic diagram of a recovery system 10 for a logging data storage according to an embodiment of the present disclosure. As shown in FIG. 1, a logging while drilling tool 11 is installed on a drill collar for logging while drilling, i.e., measuring formation physical parameters, and storing the measured LWD data in a logging data storage 13. A release transmission tool 12 can release the logging data storage 13 from the Logging while drilling tool according to certain rules, thereby releasing the logging data storage 13 into a wellbore 14 (or drilling annulus) (see the enlarged view in the circle in FIG. 1). Specifically, the release transmission tool 12 may release the logging data storage 13 at regular intervals (i.e., periodical release), may release the memory 13 according to the data volume stored in the logging data storage 13 (e.g., reaching a predetermined data volume), or may release the logging data storage 13 based on certain events (e.g., based on a release instruction from the ground). The released logging data storage 13 is carried by drilling fluid or other materials (such as sediment) in the drilling annulus 14 to a shale shaker at ground, where the logging data storage 13 is to be recovered by an automatic recovery device 15. After successful recovery, the data in the logging data storage 13 are read into a computer or analysis device 16 for analysis, and then displayed on a display platform 17 or used for other purposes.

Next, referring to FIG. 2, FIG. 2 shows a structural schematic diagram of an automatic recovery device 200 for recovering a logging data storage according to an embodiment of the present disclosure, which corresponds to the automatic recovery device 15 shown in FIG. 1. As shown, the automatic recovery device 200 includes a controller 210, an image acquisition module 220, a trapping module 230, and a spray module 240. The image acquisition module 220 is configured to acquire images of the shale shaker (and particulate matter processed by the shale shaker). One or more image acquisition modules 220 may be provided according to the structure of the shale shaker. In a specific application, the image acquisition module 220 may be installed at a discharge outlet of the shale shaker 250, may be installed on the front side of the discharge outlet of the shale shaker 250 or on the side of the discharge outlet. If the shale shaker 250 is a top-open shale shaker, the image acquisition module 220 may be installed at the top of the shale shaker 250 (i.e., according to the structure of the shale shaker 250, the image acquisition module 220 may be individually or combinatorically installed at the top of the shale shaker 250 and/or on the front and/or side of the discharge outlet), so as to perform comprehensive image acquisition and overall image recognition on the shale shaker 250 and improve the recognition accuracy and efficiency of logging data storages.

After being carried to the ground by drilling fluid in the wellbore, the logging data storage enters the shale shaker 250 together with cuttings, sediment, etc., carried by the drilling fluid for processing, and the shale shaker 250 performs solid-liquid separation on the drilling fluid, sediment, cuttings and the logging data storage. The image acquisition module 220 may image the particulate matter (including cuttings, sediment, and possible logging data storages) processed in the shale shaker. The image acquisition module 220 may also include a fluorescent excitation device (e.g., an ultraviolet lamp). In this configuration, the image acquisition module 220 may emit fluorescent excitation light (e.g., ultraviolet light) to the shale shaker (e.g., screen surface of the shale shaker) in response to a control instruction to excite the fluorescent encapsulation material of the logging data storage to generate fluorescence, thereby improving the distinctiveness of the optical features of the logging data storage.

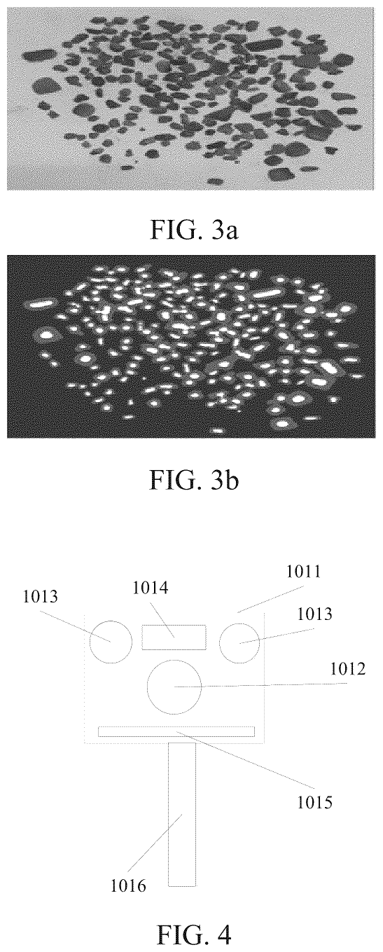

The controller 210 is coupled to the image acquisition module 220 by wire or wirelessly and is configured to receives images of the shale shaker from the image acquisition module 220. The controller 210 is further configured to analyze the received images to determine whether a logging data storage is present in the images. Specifically, the controller 210 may analyze the shapes of particulate matter in the images and determine whether there is a shape in the images that matches the shape of the logging data storage. If so, it is determined that a logging data storage is identified (see FIGS. 3a and 3b, which show the shapes of particulate matter (e.g., cuttings) identified and extracted by the controller 210 in the images).

Alternatively, the controller 210 may analyze fluorescent particles in the images. If fluorescent particles are present in the images, it is determined that a logging data storage is present. Or, the controller may simultaneously identify the shapes of particulate matter and fluorescent particles in the images and then output identification results and take further actions, including but not limited to activating the trapping module 230, sound reminders, light signal reminders, message reminders, etc.

Alternatively, the controller 210 may use a trained neural network model (e.g., a convolutional neural network model) to identify logging data storages in images.

The trapping module 230 is coupled to the controller 210. When the controller 210 determines that a logging data storage is present in the shale shaker based on image recognition, the trapping module 230 is activated. Upon being activated, the trapping module 230 is disposed to the discharge outlet of the shale shaker 250 to trap the identified logging data storage. The trapping module 230 is located below the discharge outlet of the shale shaker so that the logging data storage is intercepted, trapped or collected by the trapping module after vibrating away from the shale shaker 250.

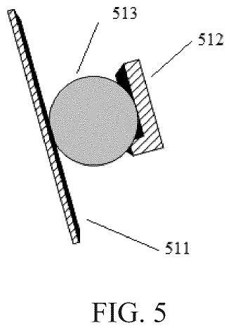

Specifically, in an optional embodiment, the trapping module 230 includes a guide plate and a trapping baffle (see FIG. 5), and the height between the trapping baffle and the guide plate is set according to the structural dimensions of the logging data storage to intercept or trap the logging data storage.

In practical applications, the height between the trapping baffle and the guide plate is set to be approximately 0.3 mm smaller than the logging data storage. Installed at the outlet of the shale shaker, the cuttings or sediment separated by the shale shaker flow directly into the trapping module. Liquid mud and small cuttings or sediment flow down the guide plate into a lower recovery device, while the logging data storage is intercepted or trapped by the trapping baffle to achieve trapping of the logging data storage.

Continuing to refer to FIG. 2, the automatic recovery device 200 further includes a spray module 240. The spray module 240 is coupled to the controller 210 and disposed adjacent to the trapping module 230, e.g., above the trapping module 230. When the trapping module 230 is activated to start trapping the logging data storage, mud, sediment or cuttings may block the trapping module 230. The controller 210 may receive measurement data from a dedicated sensor (not shown) to determine whether a blockage occurs at the trapping module 230. If so, the controller 210 may activate the spray module 240 to flush the trapping module 230, so that the mud, sediment or cuttings are discharged as soon as possible to ensure the continuity of logging data storage interception (or trapping). In one embodiment, the function of the dedicated sensor may also be implemented by the image acquisition module 220. The image acquisition module 220 acquires images of the trapping module 230, and the controller 210 determines whether a blockage occurs based on the images from the image acquisition module 220. Those skilled in the art can understand that the sensor is not limited thereto, and other dedicated sensors or algorithms may be used to determine whether a blockage occurs at the trapping module 230. Alternatively, the spray module 240 may be activated periodically after the trapping module is activated to periodically flush the trapping module 230 and avoid blockage.

Further, the controller 210 in the present disclosure may communicate with the logging while drilling tool and the release transmission tool in the wellbore (see the logging while drilling tool 11 and the release transmission tool 12 in FIG. 1). When the release transmission tool releases the logging data storage into the wellbore (or drilling annulus), it may send a release signal to the controller 210. The controller 210 receives the release signal from the release transmission tool and activates the image acquisition module 220 to acquire images (e.g., images of particulate matter processed in the shale shaker) based on the release signal. Specifically, the controller 210 receives the release signal and the depth signal of the released position of the logging data storage (e.g., from the logging while drilling tool). The controller then calculates the approximate time for the logging data storage to reach the ground based on the depth signal, wellbore diameter, and flow rate of the drilling fluid returning to the ground (flow volume per unit time). Specifically, the volume of drilling fluid in the wellbore is calculated based on the depth signal and wellbore diameter, and the approximate time for the logging data storage to reach the ground is obtained by dividing this volume by the drilling fluid flow rate. However, this calculated time may have an error of 30 minutes. The controller 210 then activates the image acquisition module 220 to acquire images based on the calculated time and considering the time error. In this way, the image acquisition module 220 is prevented from operating continuously, and the controller is prevented from continuously analyzing the acquired images, thereby reducing system load, saving power, and reducing costs.

The automatic recovery device for a logging data storage provided by the embodiments of the present disclosure recovers the releasable logging data storage for downhole data transmission, performs image recognition and automatic recovery of the logging data storage after the storage is carried by drilling fluid to the shale shaker, and activates the image acquisition module based on the release signal and uses the spray module to prevent blockage, thereby improving the automated recognition accuracy of the logging data storage, reducing power consumption and system load, and improving the recovery ratio and throughput of the logging data storage.

Next, referring to FIG. 4, FIG. 4 shows a structural schematic diagram of an image acquisition module according to an embodiment of the present disclosure. As shown, the image acquisition module includes an image acquisition device 1011 and a mounting bracket 1016. The image acquisition device 1011 uses an optical imaging device (e.g., a wide-angle high-speed optical imaging device) to image the screen surface of the shale shaker. As shown, the image acquisition device 1011 includes an optical imaging device 1012, a photosensor and natural light fill light 1013, a flash lamp 1014, and a fluorescent excitation device 1015 (e.g., an ultraviolet lamp). The photosensor monitors the light intensity information at the shale shaker 100 in real-time and transmits it to the controller. If the light intensity information meets one or more predefined fill light conditions, the natural light fill light is controlled to automatically fill light to ensure that the light intensity of the image acquisition environment is always sufficient. The fluorescent excitation device 1015 provides, for example, ultraviolet light irradiation to the screen surface of the shale shaker in response to a controller instruction to excite the fluorescent encapsulation material of the logging data storage to generate fluorescence, thereby improving the distinctiveness of the optical features of the logging data storage.

In a further embodiment, the mounting bracket 1016 is movably connected to the image acquisition device 1011 to enable the image acquisition device 1011 to rotate and lock as needed. Moreover, the mounting bracket 1016 has horizontal and vertical telescoping functions to facilitate adjusting the horizontal and vertical ranges of the image acquisition device 1011.

FIG. 5 shows a structural schematic diagram of a trapping module according to an embodiment of the present disclosure. As shown, the trapping module may include a guide plate 511 and a trapping baffle 512. The trapping baffle 512 is L-shaped and configured to intercept or collect the logging data storage 513. Alternatively, the trapping baffle 512 may be a straight baffle inclined at a certain angle relative to the guide plate 511, such that the size of the outlet of the inclined structure formed by the guide plate 511 and the trapping baffle 512 (or the spacing between the guide plate 511 and the trapping baffle 512) is smaller than the size of the logging data storage 513, thereby intercepting the logging data storage 513. Those skilled in the art should understand that the shapes of the guide plate 511 and the trapping baffle 512 in the figure are only examples, and those skilled in the art may adopt any structure that can intercept the logging data storage.

In the automatic recovery device for a logging data storage provided by the embodiments of the present disclosure, each module or unit may operate independently or in combination according to actual image acquisition needs or actual recognition needs to achieve corresponding technical effects.

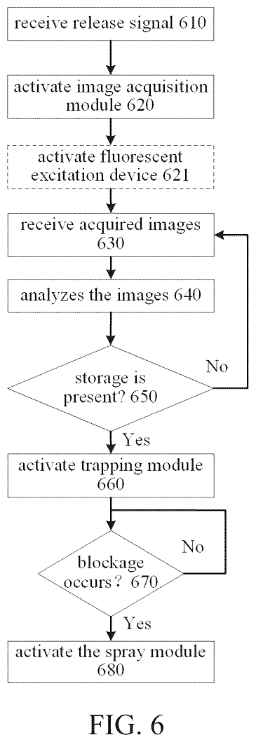

Next, referring to FIG. 6, a flowchart of a method for recovering a logging data storage according to an embodiment of the present disclosure is shown, which may be executed by the automatic recovery device 200 shown in FIG. 2.

The method begins with step 610, where the controller in the automatic recovery device receives a release signal from the release transmission tool in the wellbore, indicating that the logging data storage has been released into the wellbore (or drilling annulus). Then, at step 620, the controller activates the image acquisition module based on the release signal. After activation, the image acquisition module begins to acquire images of the particulate matter processed in the shale shaker. Specifically, the controller also determines or receives the depth signal of the released position of the logging data storage, the wellbore diameter, and the flow rate of the drilling fluid returning up to the ground. The controller then calculates the approximate time for the logging data storage to reach the ground (or the shale shaker) based on the depth signal, wellbore diameter, and flow rate of the drilling fluid returning up to the ground (flow volume per unit time). For example, the volume of drilling fluid in the wellbore is calculated based on the depth signal and wellbore diameter, and the time for the logging data storage to reach the ground is obtained by dividing this volume by the flow rate of the drilling fluid. However, this calculated time is inaccurate and may have a time error of 30 minutes. The controller then activates the image acquisition module to acquire images of the particulate matter processed in the shale shaker based on the calculated time, the release signal, and considering the time error.

Optionally, after step 620 of activating the image acquisition module, the method may include step 621, where the controller selectively activates the fluorescent excitation device (e.g., an ultraviolet lamp) as needed (e.g., for higher accuracy, depending on lighting conditions, or to prevent glare, etc.). In this case, the image acquisition module may emit fluorescent excitation light (e.g., ultraviolet light) to the shale shaker (e.g., the screen surface of the shale shaker) to excite the fluorescent encapsulation material of the logging data storage to generate fluorescence, thereby improving the distinctiveness of the optical features of the logging data storage.

The method proceeds to step 630, where the controller receives the acquired images from the image acquisition module. Then, at step 640, the controller analyzes the images, to extract the shapes of the particulate matter shown in the images and/or to obtain the fluorescent signals of the particulate matter shown in the images. At step 650, the controller determines whether a logging data storage is present in the shale shaker based on the shapes of the particulate matter and/or fluorescent signals. Specifically, the controller may recognize the shapes of the particulate matter in the images and determine whether there is a shape in the images that matches the shape of the logging data storage. If so, it is determined that a logging data storage is recognized. Alternatively, the controller may recognize fluorescent particles or substances in the images. If fluorescent particles are present in the images, it is determined that a logging data storage is present. Or, it may recognize both the shapes of the particulate matter and fluorescent particles in the images and determine whether a logging data storage is present based on both shapes and fluorescence.

If no logging data storage is recognized at step 650, the method returns to step 630. If it is determined that a logging data storage is present at step 650, the method proceeds to step 660. At step 660, the controller issues a control signal to activate the trapping module to intercept, trap or collect the recognized logging data storage. Meanwhile, at step 670, the controller receives signals from a sensor at the trapping module to determine whether a blockage occurs at the trapping module (e.g., due to the activation of the trapping module causing blockage by cuttings or sediment). If a blockage occurs, the method proceeds to step 680 to activate the spray module to flush the trapping module and remove the blockage. Alternatively, the spray module may be activated periodically after the trapping module is activated to periodically flush the trapping module and avoid blockage.

The method for recovering a logging data storage described above with reference to FIG. 6 is presented, but those skilled in the art can understand that the above steps are not necessarily executed in sequence and may be executed simultaneously or in a different order. Or, within the scope of the present application, some steps in the above method may be combined into one step, one step may be divided into multiple steps, or some steps may be omitted, as long as the method can still solve the technical problem to be solved by the present application.

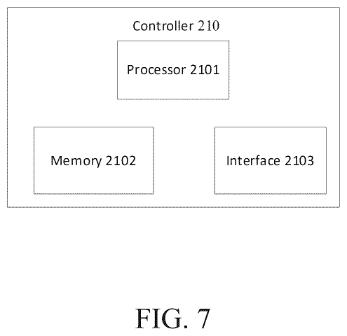

Next, referring to FIG. 7, which shows a structural diagram of the controller 210 in FIG. 2. As shown in FIG. 7, the controller 210 includes a processor 2101, a memory 2102, and an interface 2103. The processor 2101 implements the operations of the controller 210 by executing computer-executable instructions defining the method as shown in FIG. 6. A computer program product including computer-executable instructions may be stored in the memory 2102. The method described in FIG. 6 may be defined by computer-executable instructions included in a computer program product stored in the memory 2102 and realized by the processor 2101 executing the computer-executable instructions. The interface 2103 may include a network interface for communicating with other devices via a network and may also include other input/output devices (e.g., a display, keyboard, mouse, speaker, button, touchpad, touchscreen, etc.) that enable users to interact with the controller 210. Those skilled in the art will recognize that the implementation of an actual control system may also include other components, and FIG. 7 is a high-level representation of some components of such a control system for illustrative purposes.

The memory 2102 includes a tangible non-transitory machine-readable storage medium and may also include high-speed random access memory, such as dynamic random access memory (DRAM), static random access memory (SRAM), double data rate synchronous dynamic random access memory (DDR RAM), or other random access solid-state memory devices, and may include non-volatile memory, such as one or more disk storage devices (such as internal hard disks and removable disks), magneto-optical disk storage devices, optical disk storage devices, flash memory devices, semiconductor memory devices (such as erasable programmable read-only memory (EPROM), electrically erasable programmable read-only memory (EEPROM)), compact disc read-only memory (CD-ROM), digital versatile disc read-only memory (DVD-ROM) discs, or other non-volatile solid-state storage devices.

We conducted a comparative experiment between the technical solution described in this disclosure and the method in the paper “A Distributed Microchip System for Subsurface Measurement.” For ease of analysis, we used tracers capable of generating magnetism for the technical solution in the paper “A Distributed Microchip System for Subsurface Measurement.” The experimental results are as follows:

| | This Disclosure | Comparative Example |
|---|---|---|
| Released | 62 | 13 |
| Recovered | 46 | 7 |
| Recovery Ratio | 74.2% | 53.8% |

It can be seen that even with tracers capable of generating magnetism, the recovery ratio of the technical solution in this disclosure is significantly higher than that of the prior art. The storages recovered using the technical solution in this disclosure have no external damage, and spraying effectively reduces adhesion and/or blockage.

It should be understood that certain features described in the context of separate embodiments for clarity may also be provided in combination in a single embodiment. Conversely, various features described in the context of a single embodiment for simplicity may also be provided separately or in any suitable sub combination or in any other described embodiment of the present application. Certain features described in the context of various embodiments should not be regarded as essential features of those embodiments unless the embodiment is inoperative without those elements.

Although the present disclosure has been described in conjunction with specific embodiments thereof, it is evident that many alternatives, modifications, and variations will be apparent to those skilled in the art in view of the present disclosure. Accordingly, it is intended to embrace all such alternatives, modifications, and variations that fall within the spirit and broad scope of the appended claims.

1. An automatic recovery device for recovering a logging data storage released into a wellbore, comprising:
an image acquisition module disposed at a shale shaker and configured to acquire images of a screen surface of the shale shaker;
a trapping module disposed at an outlet of the shale shaker and configured to trap an identified logging data storage;
a controller coupled to the image acquisition module and the trapping module, and configured to:
activate the image acquisition module to start acquiring images of the screen surface of the shale shaker in response to receiving a release signal indicating that the logging data storage has been released into the wellbore;
receive the images from the image acquisition module;
identify whether a logging data storage is present in the images; and
activate the trapping module to trap the identified logging data storage from the shale shaker in response to the presence of a logging data storage in the images.

2. The automatic recovery device according to claim 1, wherein the controller is further configured to: identify whether the logging data storage is present in the image by recognizing a shape of particulate matter on the shale shaker shown in the image.

3. The automatic recovery device according to claim 1,
wherein activating the image acquisition module in response to receiving the release signal comprises:
determining a depth signal of the released position of the logging data storage, a diameter of the wellbore, and a flow rate of drilling fluid returning up to the ground of the earth;
calculating an approximate time for the logging data storage to reach the shale shaker based on the depth signal, the diameter of the wellbore, and the flow rate; and
activating the image acquisition module to start acquiring images of the screen surface of the shale shaker based on the approximate time.

4. The automatic recovery device according to claim 1,
further comprising a spray module configured to flush the trapping module in response to a control command to prevent or eliminate blockage.

5. The automatic recovery device according to claim 4, wherein the controller is further configured to:
determine that a blockage has occurred at the trapping module based on sensed data from a sensor; and
activate the spray module to flush the trapping module in response to the blockage.

6. The automatic recovery device according to claim 1, wherein the image acquisition module comprises a fluorescent excitation device configured to emit fluorescent excitation light to the shale shaker in response to a controller command, wherein the fluorescent excitation light is configured to excite an encapsulation material of the logging data storage to generate fluorescence.

7. The automatic recovery device according to claim 6, wherein the controller is further configured to: identify whether the logging data storage is present in the image by recognizing the shape and/or fluorescence of particulate matter on the shale shaker shown in the image.

8. The automatic recovery device according to claim 6, wherein the image acquisition module further comprises a photosensor and a natural light fill light, the photosensor configured to monitor light intensity at the shale shaker and control the natural light fill light to automatically fill light in response to the light intensity meeting a predefined fill light conditions.

9. The automatic recovery device according to claim 1,
wherein the trapping module is disposed at the outlet of the shale shaker and comprises a guide plate and a trapping baffle, and a spacing between the guide plate and the trapping baffle is set according to structural dimensions of the logging data storage to intercept the logging data storage.

10. The automatic recovery device according to claim 1, wherein the controller is further configured to issue a reminder signal in response to the presence of a logging data storage in the image.

11. A method for recovering a logging data storage released into a wellbore, comprising:
receiving a release signal indicating that the logging data storage has been released into the wellbore;
activating an image acquisition module to start acquiring images of a screen surface of a shale shaker in response to receiving the release signal;
receiving the images from the image acquisition module;
identifying whether the logging data storage is present in the images; and
activating a trapping module to trap the identified logging data storage from the shale shaker in response to the presence of the logging data storage in the images.

12. The method according to claim 11, further comprising:
identifying whether the logging data storage is present in the image by recognizing a shape of particulate matter on the shale shaker shown in the image, and/or
issuing a reminder signal in response to the presence of a logging data storage in the image.

13. The method according to claim 11, wherein activating the image acquisition module in response to receiving the release signal comprises:
determining a depth signal of the released position of the logging data storage, a diameter of the wellbore, and a flow rate of drilling fluid returning up to the ground of the earth;
calculating an approximate time for the logging data storage to reach the shale shaker based on the depth signal, the diameter of the wellbore, and the flow rate; and
activating the image acquisition module to start acquiring images of the screen surface of the shale shaker based on the approximate time.

14. The method according to claim 11, further comprising:
determining that a blockage has occurred at the trapping module based on sensed data from a sensor; and
activating a spray module to flush the trapping module in response to the blockage to eliminate the blockage.

15. The method according to claim 11, further comprising:
activating a fluorescent excitation device to emit fluorescent excitation light to the shale shaker, wherein the fluorescent excitation light is configured to excite an encapsulation material of the logging data storage to generate fluorescence.

16. The method according to claim 15, further comprising:
identifying whether the logging data storage is present in the image by recognizing the shape and/or fluorescence of particulate matter on the shale shaker shown in the image.

17. The method according to claim 11, wherein the trapping module is disposed at an outlet of the shale shaker and comprises a guide plate and a trapping baffle, the method further comprising:
setting a spacing between the guide plate and the trapping baffle according to structural dimensions of the logging data storage to intercept the logging data storage.

18. A controller comprising:
a processor; and
a non-transitory machine-readable storage medium storing computer program instructions that, when executed by the processor, cause the processor to implement the method according to claim 11.

19. A non-transitory machine-readable storage medium storing computer program instructions that, when executed by a processor, cause the processor to implement the method according to claim 11.

20. A program product having computer program instructions that, when executed by a processor, cause the processor to implement the method according to claim 11.
